(19) United States
(12) Patent Application Publication
(10) Pub. No.: US 2003/0065630 A1
(43) Pub. Date: Apr. 3, 2003

(54) Adjusting an amount owed for fueling based on vehicle characteristics

(75) Inventors: Michael Wayne Brown, Georgetown, TX (US); Rabindranath Dutta, Austin, TX (US); Michael A. Paolini, Austin, TX (US); Newton James Smith JR., Austin, TX (US)

Correspondence Address: Marilyn Smith Dawkins, International Business Machines Corporation, Intellectual Property Law Department, 11400 Burnet Road, Internal Zip 4054, Austin, TX, 78758, US

(73) Assignee: International Business Machines Corporation, Armonk, NY

(21) Appl. No.: 09/969,068

(22) Filed: Oct. 2, 2001

(51) Int. Cl. G06F 17/00

(52) U.S. Cl. 705/413; 705/400

(57) ABSTRACT

A method, system, and program for adjusting an amount owed for fueling based on vehicle characteristics are provided. Vehicle characteristics of a vehicle to be fueled utilizing the fuel pump are wirelessly read. A database is accessed to determine a vehicle status based on the read vehicle characteristics. A payment owed amount is adjusted for fueling the vehicle based on the vehicle status.

### CROSS-REFERENCE TO RELATED APPLICATIONS

The present application is related to the following co-pending applications, incorporated herein by reference:

(1) U.S. patent application Ser. No. ______ (Attorney Docket No. AUS920010696US1);

(2) U.S. patent application Ser. No. ______ (Attorney Docket No. AUS920010697US1);

(3) U.S. patent application Ser. No. ______ (Attorney Docket No. AUS920010698US1);

(4) U.S. patent application Ser. No. ______ (Attorney Docket No. AUS920010699US1) ;

(5) U.S. patent application Ser. No. ______ (Attorney Docket No. AUS920010700US1)

(6) U.S. patent application Ser. No. ______ (Attorney Docket No. AUS920010701US1);

(7) U.S. patent application Ser. No. ______ (Attorney Docket No. AUS920010702US1);

(8) U.S. patent application Ser. No. ______ (Attorney Docket No. AUS920010703US1);

(9) U.S. patent application Ser. No. ______ (Attorney Docket No. AUS920010705US1);

(10) U.S. patent application Ser. No. ______ (Attorney Docket No. AUS920010706US1);

(11) U.S. patent application Ser. No. ______ (Attorney Docket No. AUS920010707US1); and

(12) U.S. patent application Ser. No. ______ (Attorney Docket No. AUS920010708US1).

### BACKGROUND OF THE INVENTION

1. Technical Field

The present invention relates in general to computer systems and, in particular, to conservation of energy facilitated by computer systems. Still more particularly, the present invention relates to adjusting an amount owed for fueling based on vehicle characteristics.

2. Description of the Related Art

Conservation of energy, water, and other resources is of interest globally as resources become more scarce and expensive. Government policy continues to be revised in an attempt to influence citizens' actions with regard to energy consumption. However, many of these policies involve savings that occur after a long period of time with an initial investment by the consumer, and thus are not well taken advantage of. Also, many policies do not provide a large enough incentive for most people to change conservation habits.

Gasoline is a resource for which conservation is advantageous. Vehicle technology continues to improve such that consumers have options to purchase vehicles that are increasingly more fuel efficient and emissions efficient. However, whether vehicles initially have high or low fuel and emissions efficiency, that efficiency decreases over time if the vehicle is not properly maintained and vehicle parts are not replaced periodically.

Further, another factor influencing fuel efficiency is driving style. Drivers who choose a steady pace, with fewer quick stops and starts, will typically achieve a higher fuel efficiency than drivers who rapidly accelerate, quickly stop, and take other actions that utilize a greater amount of gas. In addition, drivers who utilize highways will typically achieve higher fuel efficiency than drivers choosing city streets.

Currently, the only incentive for fuel efficiency to consumers is that the consumer achieves a greater mile to gallon ratio and therefore can go farther for less. Further, rising costs of fuel do not tend to curb the amount of fuel that is utilized and while consumers are offered fuel efficient vehicles, many still opt for vehicles that often unnecessarily utilize large amounts of fuel for every mile driven, such as large sports utility vehicles (SUVs).

Further, while governments and corporations may negotiate for discounted fuel rates, employees must utilize special fuel pumps, typically located at a station or office, to receive the discounted fuel. Such locations are typically out of the way for employees and thus require additional travel and time. In addition, employees often still need to stop at gas stations for refreshments, food and other items. Thus, time and mileage are utilized for employees to fuel vehicles at special locations and then to also visit convenience stores associated with gas stations.

Therefore, in view of the foregoing, it would be advantageous to provide fee additions or reductions at the gas pump according to characteristics of a vehicle, including the actual miles per gallon and operational efficiency of the vehicle. Further, it would be advantageous to adjust prices at the pump according to the occupational or other status of an individual such that gas station activities can be combined.

### SUMMARY OF THE INVENTION

In view of the foregoing, it is therefore an object of the present invention to provide an improved computer system.

It is another object of the present invention to provide a method, system and program for conservation of energy facilitated by computer systems.

It is yet another object of the present invention to provide a method, system and program for adjusting an amount owed for fueling based on a vehicle characteristics.

According to one aspect of the present invention, vehicle characteristics of a vehicle to be fueled utilizing the fuel pump are wirelessly read. A database is accessed to determine a vehicle status based on the read vehicle characteristics. A payment owed amount is adjusted for fueling the vehicle based on the vehicle status.

According to another aspect of the present invention, vehicle usage information is monitored for a vehicle. Then, in response to detecting a fuel pump to be utilized for fueling the vehicle, the vehicle usage information and vehicle identity information are transmitted to the fuel pump, such that the fuel pump is enabled to adjust an amount owed for fueling of the vehicle according to the vehicle usage information and the vehicle identity information.

According to yet another aspect of the present invention, vehicle characteristics for a particular vehicle are received. A vehicle status database is filtered according to the vehicle characteristics of the particular vehicle. A vehicle status is determined for the particular vehicle according to the filtering of the vehicle status database, wherein the vehicle status defines an adjustment to be made to an amount owed for fueling the particular vehicle.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a simplified block diagram of a client/server environment in which promoting and controlling energy conservation may be performed in accordance with the method, system and program of the present invention;

FIG. 3 depicts a block diagram of multiple types of servers and clients that may be utilized to promote and control conservation of energy in accordance with the method, system, and program of the present invention;

FIG. 4 illustrates a block diagram of a fuel payment amount owed adjustment system in accordance with the method, system, and program of the present invention;

FIG. 5 depicts a record from an individual vehicle characteristics database in accordance with the method, system, and program of the present invention;

FIGS. 6a-6b illustrates a table from a vehicle status database and fee scale for vehicle status database in accordance with the method, system, and program of the present invention;

FIG. 7 depicts a graphical representation of a fuel pump in accordance with the method, system, and program of the present invention;

FIG. 8 illustrates a high level logic flowchart of a process and program for monitoring vehicle characteristics in accordance with the method, system, and program of the present invention;

FIG. 9 depicts a high level logic flowchart of a process and program for adjusting payment owed in accordance with the method, system, and program of the present invention; and

FIG. 10 illustrates a high level logic flowchart of a process and program for determining vehicle status according to vehicle characteristics in accordance with the method, system, and program of the present invention.

### DETAILED DESCRIPTION OF THE PREFERRED EMBODIMENT

A method, system, and program for adjusting an amount owed for fueling a vehicle based on vehicle characteristics are provided. For purposes of the present invention, fuel may include multiple types of vehicle fluids including gasoline, coolants, oil, radiator fluid, transmission fluid, differential fluid and other fluids that are utilized in a vehicle. Therefore, a fuel pump may be utilized to adjust prices for multiple vehicle fluids including gasoline, coolants, oil, radiator fluid, transmission fluid, differential fluid and other fluids that are utilized in a vehicle.

In addition, for purposes of the present invention, an amount owed may be adjusted by a value at the pump or may include rebates and reductions to other accounts. Further, for purposes of the present invention, an amount owed may further be adjusted before fueling where a user indicates an amount of fuel needed or where the price per gallon is adjusted prior to fueling.

Specifically, for purposes of the present invention, multiple incentive features may be implemented to adjust the amount owed for fuel. A rebate is applied at some point after the fuel has been paid for. For example, an income tax deduction may be provided as a rebate.

Another type of incentive may reward limiting fueling each period by providing a rebate at the end of the period if total gallons used is less than a pre-set amount. For example, a vehicle may be given an allotment of 500 gallons per year, where at the end of the year a rebate is provided for the cost of the gasoline. In another example, a user may receive the first 500 gallons during the year at a first, lower rate and any fuel after 500 gallons at a second, higher rate.

An exemption adjusts the tax applied at the time money is changing hands. For example, the fuel tax may be reduced according to an exemption. An incentive occurs at the time money is changing hands and may reduce an amount owed by a percentage or raw number. For example, an incentive may reduce the amount owed for fuel by 5% of the amount owed.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

### Hardware Overview

The present invention may be executed in a variety of systems, including a variety of computing systems and electronic devices under a number of different operating systems. In one embodiment of the present invention, the computing system is a portable computing system such as a notebook computer, a palmtop computer, a personal digital assistant, a telephone or other electronic computing system that may also incorporate communications features that provide for telephony, enhanced telephony, messaging and information services. However, the computing system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

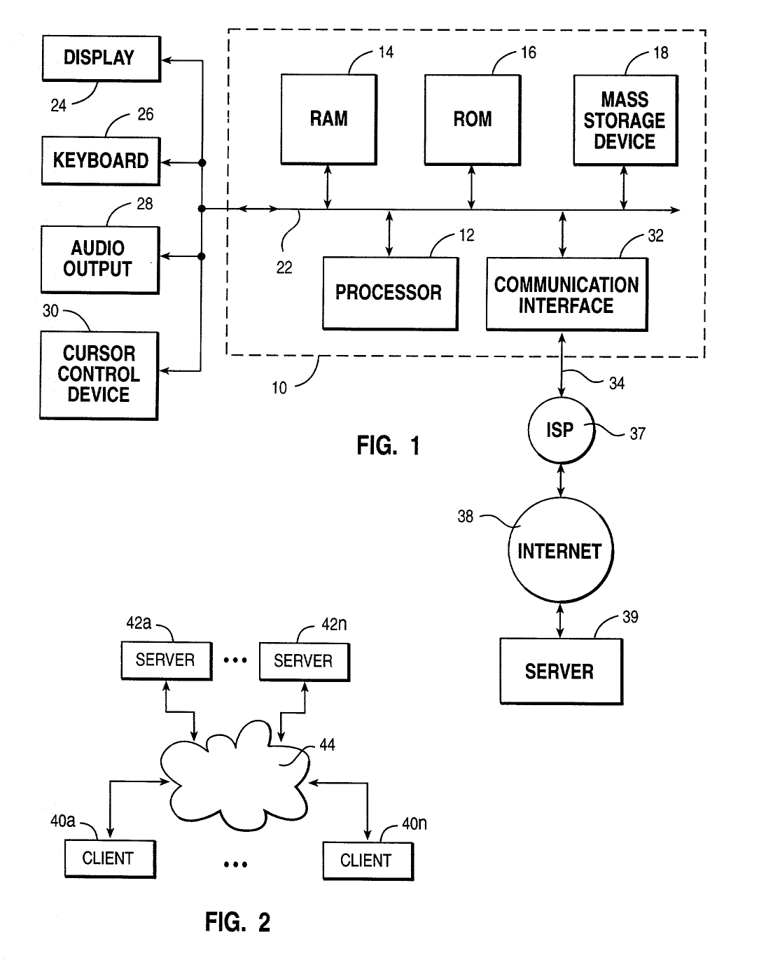

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

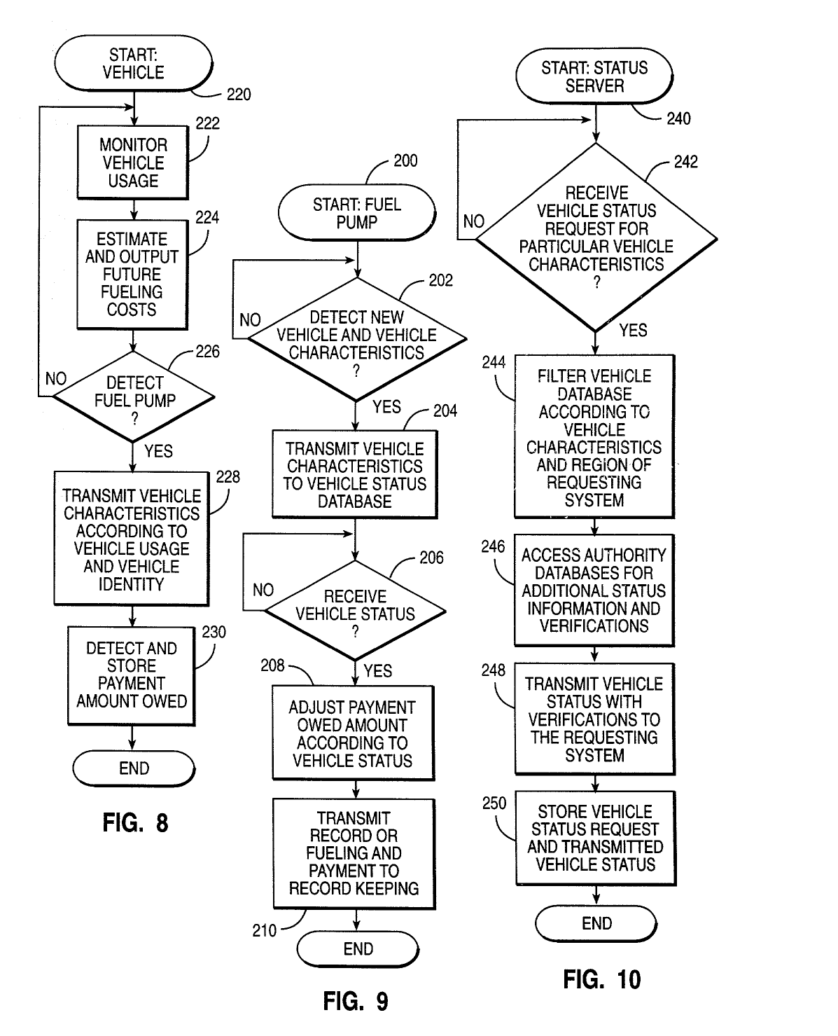

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 8, 9, 10, and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital or analog data streams. The signals through the various networks and the signals on network link 34 and through communication interface 32, which carry the digital or analog data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added.

### Networking Overview

With reference now to FIG. 2, there is depicted a simplified block diagram of a client/server environment in which promoting and controlling energy conservation may be performed in accordance with the method, system and program of the present invention. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). In the Web environment, web browsers such as Netscape Navigator typically reside on client system 40a-40n and render Web documents (pages) served by server systems 42a-42n. Additionally, each of client systems 40a-40n and server systems 42a-42n may function as both a “client” and a “server” and may be implemented utilizing a computer system such as computer system 10 of FIG. 1.

The Web may refer to the total set of interlinked hypertext documents residing on servers all around the world. Network 44, such as the Internet, provides an infrastructure for transmitting these hypertext documents between server systems 42a-42n and client systems 40a-40n. Documents (pages) on the Web may be written in multiple languages, such as Hypertext Markup Language (HTML) or Extensible Markup Language (XML), and identified by Uniform Resource Indicators (URIs) that specify the particular server and pathname by which a file can be accessed, and then transmitted from that server to an end user utilizing a protocol such as Hypertext Transfer Protocol (HTTP). Web pages may further include text, graphic images, movie files, and sounds as well as Java applets and other small embedded software programs that execute when the user activates them by clicking on a link.

It is advantageous in the present invention to utilize both wireless and wired network connections to network 44. In particular, wireless network connections are advantageous for transmission of data between vehicles and fuel pumps. Wireless network connections may be implemented utilizing Bluetooth™ or other radio frequency broadcasting. In addition, a scan may be made of a vehicle identification number or other identification easily detectable from a vehicle or provided by a driver. Advantageously, whether wireless or wired network connections are utilized, multiple types of encryption security features may be utilized to protect transmission of vehicle and driver identity information, as will be understood by one skilled in the art.

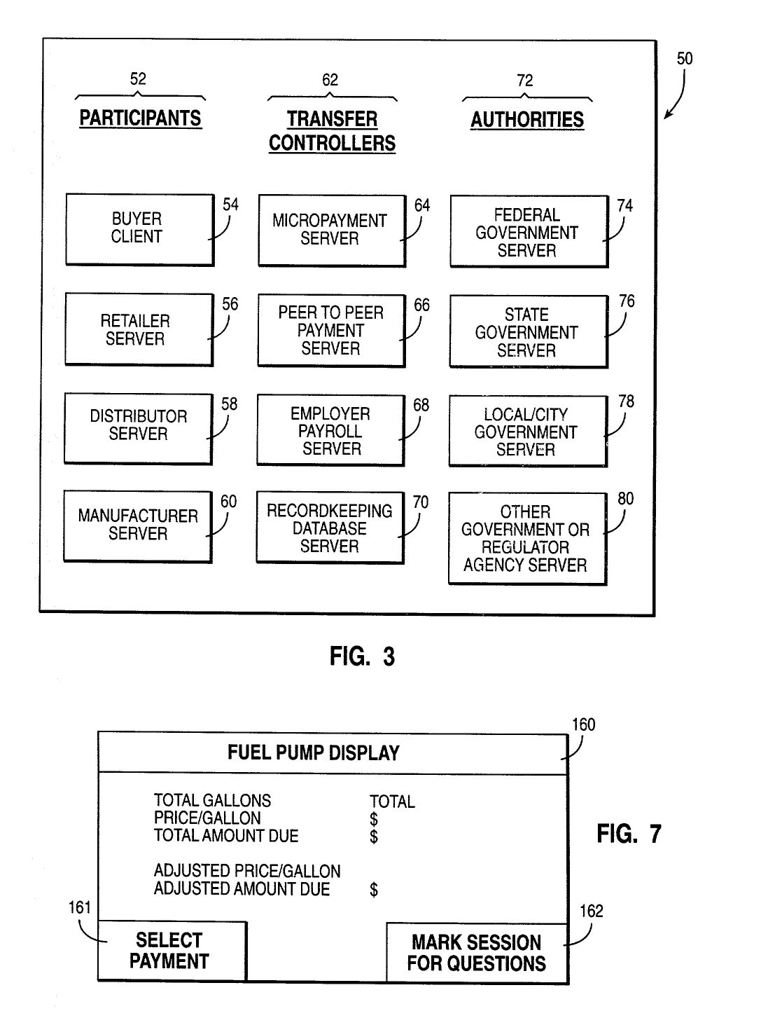

Referring now to FIG. 3, there is depicted a block diagram of multiple types of servers and clients that may be utilized to promote and control conservation of energy in accordance with the method, system, and program of the present invention. As illustrated, multiple client and server elements 50 are divided according to category. In the present embodiment categories include, but are not limited to, participants 52, transfer controllers 62, and authorities 72.

Participants 52 advantageously include all levels of people, business, and corporations involved energy conservation. In the present embodiment, participants 52 include, but are not limited to, a buyer client 54, a retailer server 56, a distributor server 58, and a manufacturer server 60. Buyer client 54 may represent the system provided to the end user of a product or service. In the present embodiment, buyer client 54 is the system with which the end user purchases fuel. Retailer server 56 may represent the retail outlet at which the buyer purchases a product or service. In the present embodiment, retailer server 56 is the server system with which buyer client 54 interacts to purchase fuel. Distributor server 58 and manufacturer server 60 represent additional levels of distribution of a product or service. In the present embodiment, distributor server 58 preferably tracks distribution of fuel from a manufacturer to retailers and buyers.

Transfer controllers 62 advantageously include all levels of controllers that may be provided for transferring adjustments to monetary amounts in response to conservation or lack of conservation by at least one of participants 52. In the present embodiment, transfer controllers 62 include, but are not limited to, a micropayment server 64, a peer-to-peer payment server 66, an employer payroll server 68, and a recordkeeping database server 70. Micropayment server 64 is advantageously a server system to which electronic micropayments may be made. In the present embodiment, a micropayment may be made from an authority system to micropayment server 64 as an adjustment to an amount owed for fuel. Micropayment server 64 may then transfer the micropayment to buyer client 54. Peer-to-peer payment server 66 is advantageously a server system from which and to which electronic payments may be made. Advantageously, peer-to-peer payment server 66 may function as an account into which and out of which electronic payments may be made. An employer payroll server 68 tracks employee time and pay. In addition, in the present embodiment, adjustments to an amount owed for fuel may be transmitted as rebates to employer payroll server 68 to be rebated on an employee paycheck. Recordkeeping database server 70 preferably maintains records of transfers of adjustments to amounts owed for products and services. In the present embodiment, recordkeeping database server 70 maintains records of transfers of adjustments to amounts owed for fuel from authority systems 72 to transfer controllers 62 and/or participants 52.

Authorities 72 advantageously include all levels of government and policy setting groups that may be responsible for setting policy and standards to adjust monetary amounts in response to conservation or lack of conservation by at least one of participants 52. In the present example, authorities 72 specifically includes federal government (govt) server 74, state government server 76, local/city government server 78, and other government or regulatory agency servers 80. Advantageously, each of the authorities 72 may determine an adjustment to an amount owed for fuel in the form of, for example, a rebate, an exemption, or an incentive. As a further advantage, multiple authorities 72 may determine an adjustment of an amount owed for fuel. For example, local/city government server 78 may determine an adjustment according to local fuel economy standards, state government server 76 may add an adjustment according to state fuel economy standards, and federal government server 74 may add an adjustment according to federal fuel economy standards.

### Fuel Amount Owed Adjustment Context

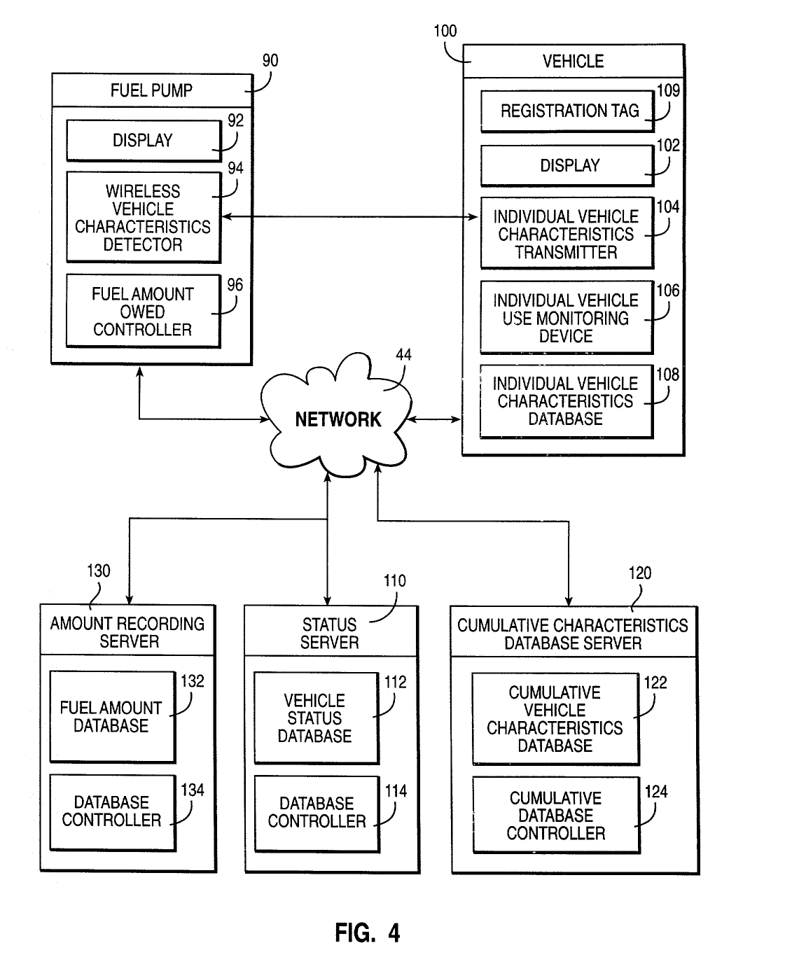

With reference now to FIG. 4, there is depicted a block diagram of a fuel payment amount owed adjustment system in accordance with the method, system, and program of the present invention. Advantageously, the fuel payment amount owed adjustment system may be utilized to promote conservation of fuel and other auto related resources.

As illustrated, a vehicle 100 is a participant system, such as buyer client 54 of FIG. 3. Vehicle 100 may include a display 102, an individual vehicle characteristics transmitter 104, an individual vehicle use monitoring device 106, an individual vehicle characteristics database 108, and a registration tag 109. Advantageously, individual vehicle use monitoring device 106 monitors multiple aspects of vehicle use including, but not limited to, miles per gallon of the vehicle, operational efficiency of the vehicle, average number of passengers per mile, types of roadways utilized, replacement of parts in the vehicle, and other aspects of vehicle use that affect fuel, emissions, and other resource related efficiency. Vehicle use monitor device 106 may utilize multiple sensors within the vehicle for monitoring vehicle use. For example, a video sensor may detect the number of passengers in the vehicle. In another example, a sensor located near each part may detect when the part is replaced. Further, a sensor may detect whether seatbelts are properly utilized.

Data monitored by individual vehicle use monitoring device 106 is preferably stored in individual vehicle characteristics database 108. In addition to vehicle use, individual vehicle characteristics database 108 advantageously includes identity information about the vehicle including a vehicle history, vehicle ownership, estimated miles per gallon, a preferred parts list, and vehicle make, model, year, version, and other identification information. In particular, vehicle ownership may be further specified according to a profession, disability, age or other status for which adjustments to fuel costs are made.

In addition, the portions of identity information involving the driver/owner and status may be provided to individual vehicle characteristics database 108 from a smart card or other personal identification device from the current driver. Advantageously, where a vehicle is driven by multiple people, each with a unique status, the vehicle characteristics can be stored according to driver and fuel amount adjustments made according to driver.

According to one aspect of the present invention, individual vehicle characteristics transmitter 104 transmits a selection of information from individual vehicle characteristics database 108 for detection by fuel pump 90. Individual vehicle characteristics transmitter 104 may transmit vehicle characteristics information within a particular range, may require detection of fuel pump 90 prior to transmission of the vehicle characteristics information, and may transmit vehicle characteristics information only after an election by a driver to transmit such information.

In particular, individual vehicle characteristics transmitter 104 advantageously utilizes a radio frequency broadcast or other wireless transmission that is detectable at fuel pump 90. In particular, Bluetooth technology may be further implemented within individual vehicle characteristics transmitter 104. Further, individual vehicle characteristics transmitter 104 may utilize a level of security, such as encryption, in transmitting the selection of information from individual vehicle characteristics database 108.

As illustrated, a fuel pump 90 is a participant system, such as retailer server 56, distributor server 58, or manufacturer server 60 of FIG. 3. Fuel pump 90 includes a display 92, a wireless vehicle characteristics detector 94, and a fuel amount owed controller 96. Wireless vehicle characteristics detector 94 advantageously detects transmissions of vehicle characteristics information from vehicle 100. In addition, wireless vehicle characteristics detector 94 may transmit a signal indicating the position, type and security features of fuel pump 90. Further, after receiving vehicle characteristics information at wireless vehicle characteristics detector 94, a user may be required to input a verification identification or other input to verify that the vehicle characteristics detected by vehicle characteristics detector 94 are those matching the user's vehicle. In addition, an input may be required to decrypt secured vehicle characteristics information.

In addition to or as an alternative to detecting vehicle characteristics information transmitted from individual vehicle characteristics transmitter 104, wireless vehicle characteristics detector 94 may detect registration tag 109 on vehicle 100. Registration tag 109 is advantageously a registration number associated with vehicle 100 for identifying the vehicle. Registration tag 109 may be scannable via multiple scanning methods, as will be understood by one skilled in the art.

Advantageously, by scanning a registration number from registration tag 109, the registration number may be transmitted to a cumulative characteristics database server 120 with a request for vehicle characteristics information associated with the registration number. According to one embodiment of the present invention, cumulative characteristics database server 120 may be provided by an authority or may be maintained by a private service.

A cumulative database controller 124 responds to requests via network 44 for vehicle characteristics information received at cumulative characteristics database server 120 according to registration number by searching a cumulative vehicle characteristics database 122. In particular, security features may be provided by cumulative database controller 124 for controlling the release of vehicle characteristics information according to a user identification in addition to a registration number.

As a further advantage of the present invention, vehicle use and identity information may be transmitted from vehicle 100 to a remote location, such as cumulative vehicle characteristics database 122, via network 44 according to registration number. Further, a mechanic or other vehicle specialist may provide information to cumulative vehicle characteristics database 122 about vehicle 100, such as repairs made to vehicle 100 that would effect fuel efficiency. In particular, to update cumulative vehicle characteristics database 122, a mechanic is preferably required to provide an identifier that authorizes making updates and identifies the person making the changes. In addition, any updates to cumulative vehicle characteristics database 122 are preferably individually updated according to vehicle within individual vehicle characteristics database 108.

Once vehicle characteristics information is detected by wireless vehicle characteristics detector 94, the vehicle characteristics information is transmitted to a status server 110 via network 44 with a request for a vehicle status based on the vehicle characteristics information. Advantageously, database controller 114 filters a vehicle status database 112 according to the vehicle characteristics information and returns a vehicle status to fuel pump 90. The vehicle status may include a type of adjustment to the amount owed for fuel and/or may include a ranking among particular levels of fuel efficiency ratings.

According to one embodiment of the present invention, status server 110 is utilized to access all of the available authority systems. However, in alternate embodiments, status server 110 may represent a single authority system. Further, in alternate embodiments, each authority system may individually receive the vehicle status request.

In particular, vehicle status database 112 may include multiple standards according to multiple authorities for judging whether the vehicle characteristics information warrants adjustments in the amount owed for fuel. In particular, policies may be set by authorities and other groups who will provide the monetary backing for adjustments in the amount owed for fuel according to vehicle characteristics. Examples of adjustments in the amount owed for fuel may include, but are not limited to, a tax exemption, a tax rebate, an additional fee, and a fee reduction.

Fuel amount owed controller 96 receives the vehicle status and adjusts an amount owed according to the assigned vehicle status. The adjustment in fuel amount owed is preferably output via display 92.

Adjustments may both increase and decrease an amount owed. Further, the adjustment in the amount owed may be applied to the cost of fuel per gallon or may be applied to the total amount of fueling. Moreover, the adjustment in the amount owed may reflect a payment made to a transfer controller, such as a micropayment server, peer-to-peer payment server, employer payroll server, or recordkeeping database server. For example, if a tax rebate is provided as an adjustment in the amount owed, a record of the tax rebate will be transmitted to a recordkeeping database server; however, the provision of a rebate will be displayed with the amount owed.

A user may pay for the cost of fueling utilizing traditional methods such as credit card and cash. In addition, a user may provide an identification for an account to be charged such that fuel pump 90 accesses a payment server with an account associated with the user. For example, a user may provide an identification for an account utilizing a smart card where the account references a particular business' micropayment server.

Fuel amount owed controller 96 transmits the amount originally owed, the amount owed after adjustment, and verification of payment of the amount owed to an amount recording server 130 via network 44. Amount recording server 130 includes a fuel amount database 132 in which the amounts are stored according to a registration number for the vehicle, according to the user making payment, and other identifying information. Database controller 134 responds to requests for information about adjustments to amounts owed by a user, a retailer, a manufacturer, an employer, a government office, or other policy making systems.

For the purposes of illustrating the advantages of the present invention, several illustrative examples of application of the present invention are herein described. First, adjustments to the amount owed for fuel may be provided purely by the type of vehicle and expected vehicle usage statistics, independent of the vehicle usage. For example, a tax discount may be given for fueling of economy vehicles and other vehicles that have been determined to achieve an acceptable fuel efficiency rating. Accordingly, the effect of providing a tax discount for vehicles with a high fuel efficiency rating is that in addition to consumers receiving more miles to the gallon, the consumer also receives a cheaper cost per gallon than cars that are less fuel efficient by design.

In addition to the type of vehicle, the intended purpose of the vehicle may also be considered. For example, if a large passenger vehicle is purchased for carpooling or other purposes where the vehicle will be full a majority of the time, tax discounts may be provided according to the purpose of the vehicle. With such a discount, businesses and organizations needing large occupancy vehicles will be given a discount for utilizing those vehicles to hold a large number of passengers.

As another example, adjustments to the amount owed may be provided according to the actual usage of a vehicle. For example, the actual fuel efficiency of a vehicle may be utilized to determine whether a tax discount will be received. Such a discount would benefit owners of vehicles that maintain the vehicle and drive the vehicle in a manner such as to achieve a high fuel efficiency in comparison with the estimated fuel efficiency. For example, a driver who chooses to use the highway when possible and avoids constant quick stops and starts would achieve a higher fuel efficiency and preferably be rewarded for such choices with a discount, even though the driver may not be driving a car that is in the fuel economy class of cars with a higher initial fuel efficiency rating.

Further, an adjustment to the amount owed for fuel may be made according to the membership status of the driver. For example, it may be advantageous to include tax discounts for fueling to senior citizens and disabled drivers in combination with other tax relief programs for those individuals. In another example, it may be advantageous for a school district, county, city, state or country to provide fuel tax discounts to employees, such as teachers, to provide an incentive for people to take a teaching job within a particular area.

An advantage of adjusting the amount owed for fuel according to the membership status of the driver will allow drivers of government vehicles to receive gasoline tax free and/or at a fuel rate specially negotiated for the government with a fuel supplier. Such adjustments for specially negotiated fuel rates may also be provided to persons of other membership status. For example, a particular fuel distributor may negotiate with a teacher's union to provide fuel to teachers at a special rate.

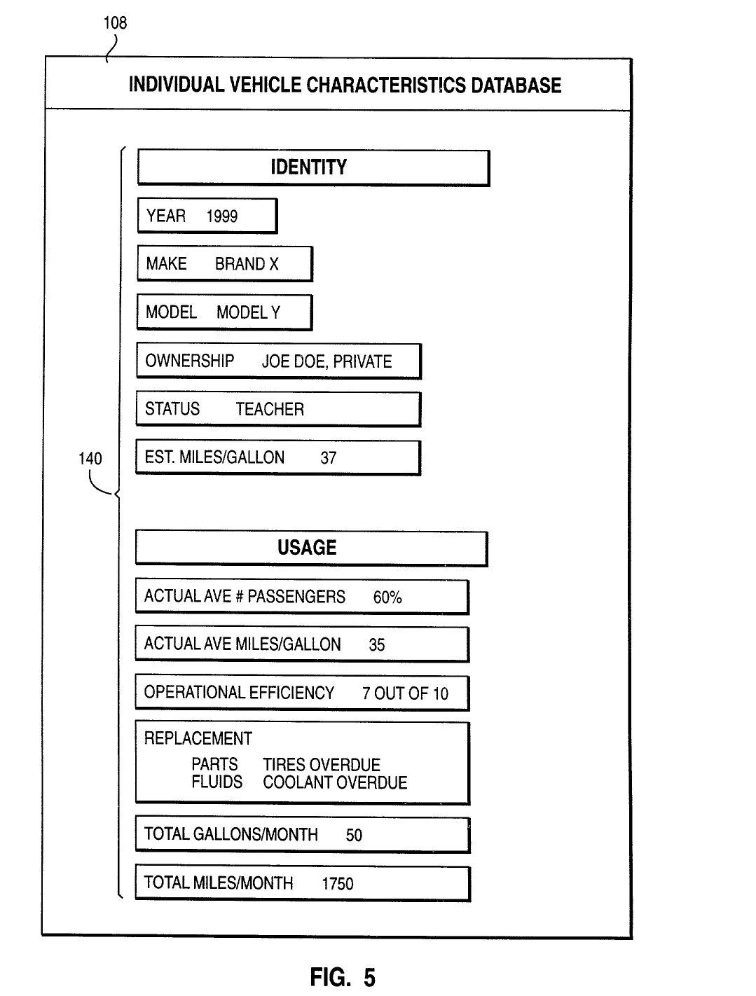

Referring now to FIG. 5, there is depicted a record from an individual vehicle characteristics database in accordance with the method, system, and program of the present invention. As illustrated, a record 140 from individual vehicle characteristics database 108 includes multiple categories for representing vehicle characteristics. In the present embodiment, categories are initially divided according to whether the characteristic is an identity characteristic or a usage characteristic.

With identity characteristics, the year, make, model, and registration number of a vehicle are indicated. In addition, an ownership of the vehicle and status of the owner are provided. In particular, ownership of the vehicle advantageously includes an individual, business, or government who owns the vehicle and whether the vehicle is privately or publicly owned. Owner/driver status characteristics, such as whether the owner/driver is a senior citizen, disabled, a teacher, or a government employee, may be provided. In particular, the owner may differ from the driver in many situations. Further, identity characteristics may include information about the vehicle such as predicted miles/gallon, preferred parts, estimated requirements for part and fluid replacement and other information related to the performance of the vehicle.

With usage characteristics, the average actual number of passengers may be monitored. In the present example, the average number is output as a percentage of the total seats available and average number of passengers per mile occupying those seats. Further, usage characteristics may include the actual average miles per gallon as measured according to miles traveled and gallons utilized. In addition, an operational efficiency may be calculated where the operational efficiency represents a combination of whether the user chose highway routes where possible, rather than local streets with multiple stop lights. Further, the operational efficiency may include the acceleration and deceleration utilized by the driver, where frequent quick stops and starts decrease operational efficiency. Advantageously, a vehicle includes sensors that detect the level of fluids and the wear on parts, such that replacement parts and fluids may be recommended within usage characteristics. Additionally, a usage characteristic may include the total number of miles driven and gallons of fuel utilized for each month and further for each year.

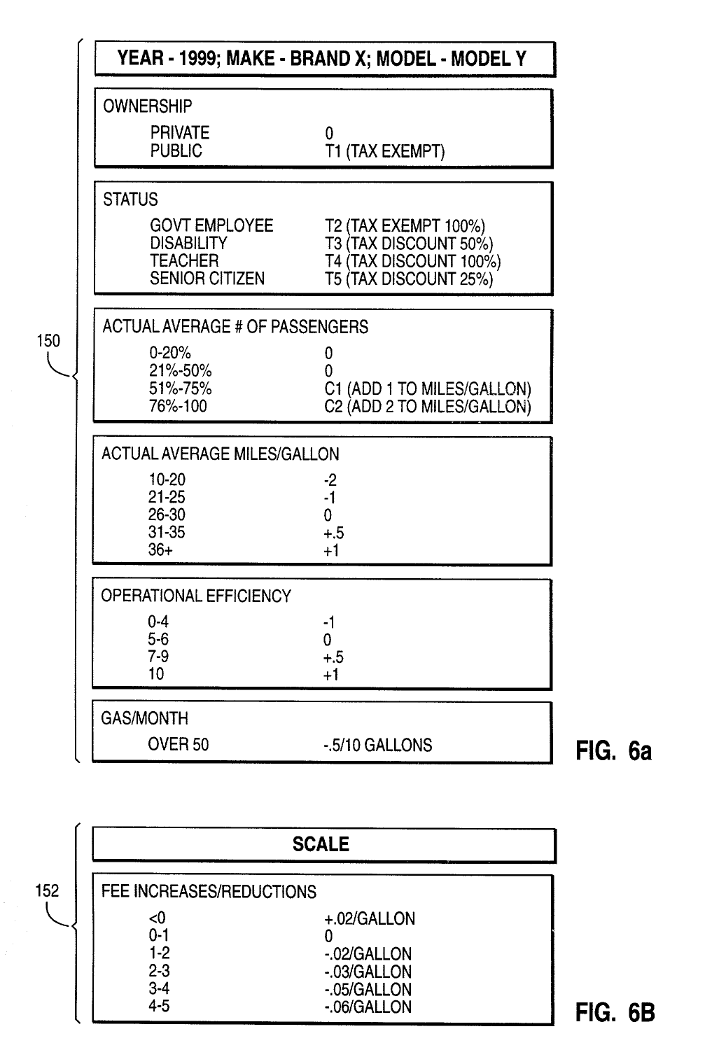

With reference now to FIGS. 6a-6b, there is illustrated a table from a vehicle status database and fee scale for vehicle status database in accordance with the method, system, and program of the present invention. As depicted, a table 150 within a vehicle status database includes multiple categories for determining a vehicle status based on the vehicle characteristics. In the present example, the vehicle status variables are specified for the make, model, and year of the vehicle described in FIG. 5. In alternate embodiments, vehicle status variables may be specified for alternate vehicles. In addition, in alternate embodiments, vehicle status variables may be specified for groups or types of vehicles.

In the example, a tax exemption number is associated with ownership and owner status. For the vehicle characteristics of FIG. 5, tax exemption “T4” will be applied since the owner is a teacher. Tax exemption “T4” is advantageously associated with a particular type of fuel tax cost adjustment specified for teachers.

In addition, a carpool number is associated with the average number of passengers. For the vehicle characteristics of FIG. 5, carpool status “C1” will be applied to the adjustment total because the average number of passengers averaged 60% of the total capacity.

Further, in the example, numerical values are assigned to particular levels of vehicle characteristics that provide for fee additions or reductions. For example, positive and negative amounts are assigned to actual average miles per gallon, operational efficiency, and gallons over the maximum gallons per month rate.

A scale 152 within a vehicle status database is provided for converting the numerical values into monetary adjustments. For example, if a numerical value is less than 0, then an increase of $0.02 per gallon is made. On the other hand, if a numerical value is between 2 and 3, then a reduction of $0.03 is made.

Advantageously, the combination of tax exemption numbers, carpool numbers and numerical values may be compared with a scale for determining vehicle status. Vehicle status may include tax exemptions, tax rebates, and fee additions and reductions. For example, the carpool status may be utilized to supplement the miles per gallon value, such that a driver is given incentive to drive multiple passengers even though the miles per gallon may be reduced.

Referring now to FIG. 7, there is depicted a block diagram of a display for a fuel pump in accordance with the method, system, and program of the present invention. As illustrated a display area 160 includes the total gallons pumped, the price per gallon, the total amount owed, the adjusted price per gallon, and the adjusted amount owed after vehicle status adjustments. In addition, the variables utilized for determining status and the vehicle status may be depicted.

In particular, a selectable button, such as selectable button 161, may be provided for a user to make a payment selection. In addition, a selectable button 162 may be provided for a user to identify a fueling session where errors appear to have occurred in calculation of the adjusted price per gallon or other charge related questions. In addition, a user may provide a voice message or text message identifying the question. By marking a fueling session, the user may then contact the authority providing the incentives and may quickly identify a questioned fueling session.

With reference now to FIG. 8, there is illustrated a high level logic flowchart of a process and program for monitoring vehicle characteristics in accordance with the method, system, and program of the present invention. As depicted, the process starts at block 220 and thereafter proceeds to block 222.

Block 222 illustrates monitoring vehicle usage according to miles per gallon, operational efficiency, average number of passengers per mile, replacement of parts, replacement of fluids, and other usage measurements. The monitored vehicle usage may be stored local or remote to the vehicle. Next, block 224 depicts estimating and outputting future fueling costs on a display within the vehicle; and the process passes to block 226. In estimating future fueling costs, the vehicle may transmit the vehicle characteristics to the status server to receive an estimated vehicle status for use in making the estimation.

Block 226 depicts a determination as to whether or not a fuel pump is detected. If a fuel pump is not detected, then the process passes to block 222. If a fuel pump is detected, then the process passes to block 228.

Block 228 illustrates transmitting the vehicle characteristics according to vehicle usage and vehicle identity to the fuel pump. Next, block 230 depicts detecting and storing the payment amount owed; and the process ends.

Referring now to FIG. 9, there is depicted a high level logic flowchart of a process and program for adjusting payment owed in accordance with the method, system, and program of the present invention. As illustrated, the process starts at block 200 and thereafter proceeds to block 202.

Block 202 illustrates a determination as to whether or not a new vehicle and the vehicle characteristics are detected. A new vehicle may be detected by multiple types of sensing devices. New vehicle characteristics may be detected from an infrared or RF transmission from a vehicle or may be accessed by referencing a registration identification for the vehicle from a cumulative characteristics database server. If a new vehicle and new vehicle characteristics are not detected, then the process iterates at block 202. If a new vehicle and new vehicle characteristics are detected, then the process passes to block 204.

Block 204 depicts transmitting the vehicle characteristics to the vehicle status database server. Next, block 206 illustrates a determination as to whether or not a vehicle status is received. If a vehicle status is not received, then the process iterates at block 206. If a vehicle status is received, then the process passes to block 208.

Block 208 illustrates adjusting the payment owed amount according to the vehicle status. Next, block 210 depicts transmitting a record of the fueling and amount owed to a record keeping server system; and the process ends.

With reference now to FIG. 10, there is illustrated a high level logic flowchart of a process and program for determining vehicle status according to vehicle characteristics in accordance with the method, system, and program of the present invention. As depicted, the process starts at block 240 and thereafter proceeds to block 242.

Block 242 depicts a determination as to whether or not a vehicle status request is received with vehicle characteristics. If a vehicle status request is not received, then the process iterates at block 242. If a vehicle status request is received, then the process passes to block 244.

Block 244 illustrates filtering a vehicle status database according to vehicle characteristics. Next, block 246 depicts accessing authority databases for additional status information and verifications. Authority databases may include government databases. In addition, authority databases may include employer or other databases that maintain records of employment status or other status that allows a user to receive adjustments. Further, authority databases may be accessed according to a regional location of the vehicle, wherein specific regional government status databases may be utilized. Thereafter, block 248 illustrates transmitting the vehicle status with verifications to the requesting system. Further, block 250 depicts storing the vehicle status request and transmitted vehicle status according to time and date; and the process ends.

While the invention has been particularly shown and described with reference to a preferred embodiment, it will be understood by those skilled in the art that various changes in form and detail may be made therein without departing from the spirit and scope of the invention.

What is claimed is:

1. A fuel pump comprising:
means for reading vehicle characteristics of a vehicle to be fueled utilizing said fuel pump; and
means for adjusting a payment owed amount for fueling said vehicle based on a vehicle status determined from said vehicle characteristics.

2. The fuel pump according to claim 1, said fuel pump further comprising:
means for accessing a database to determine said vehicle status based on said vehicle characteristics.

3. The fuel pump according to claim 1, wherein said vehicle status is at least one of a tax exemption, a tax rebate, an additional fee, and a fee reduction.

4. The fuel pump according to claim 1, wherein said vehicle characteristics comprise at least one of a vehicle type, a type of ownership of said vehicle, a predicted mileage per gallon of said vehicle, an actually computed mileage per gallon of said vehicle, an operational efficiency, and an average number of passengers carried per mile.

5. The fuel pump according to claim 4, wherein said type of ownership comprises at least one of an indication of whether said vehicle is privately or publicly owned, and then whether said vehicle is owned by at least one of a senior citizen group, a person with a disability, a government worker, and a teacher.

6. The fuel pump according to claim 1, wherein said means for reading vehicle characteristics of a vehicle further comprises:
means for wirelessly reading said vehicle characteristics of said vehicle from a computer system onboard said vehicle.

7. The fuel pump according to claim 1, wherein said means for adjusting a payment owed amount for fueling said vehicle based on said vehicle status further comprises:
means for comparing said vehicle status with vehicle standards; and
means for adjusting said payment owed amount according to a difference between said vehicle status and said vehicle standards.

8. The fuel pump according to claim 1, wherein said means for adjusting a payment owed amount for fueling said vehicle based on said vehicle status further comprises:
means for adjusting said payment owed amount by subtracting taxes.

9. The fuel pump according to claim 1, wherein said means for adjusting a payment owed amount for fueling said vehicle based on said vehicle status further comprises:
means for adjusting said payment owed amount by subtracting an efficient usage amount.

10. The fuel pump according to claim 1, wherein said means for adjusting a payment owed amount for fueling said vehicle based on said vehicle status further comprises:
means for adjusting said payment owed amount by subtracting an employment incentive amount.

11. A method for determining fuel pumping costs, said method comprising the steps of:
reading vehicle characteristics of a vehicle to be fueled utilizing said fuel pump; and
adjusting a payment owed amount for fueling said vehicle based on a vehicle status determined from said vehicle characteristics, such that costs of fueling are adjusted at said fuel pump.

12. The method for determining fuel pumping costs according to claim 11, said method further comprising the step of:
accessing a database to determine said vehicle status based on said vehicle characteristics.

13. The method for determining fuel pumping costs according to claim 11, said step of adjusting a payment owed amount further comprising the step of:
adjusting said payment owed amount for fueling said vehicle based on said vehicle status comprising at least one from among a tax exemption, a tax rebate, an additional fee, and a fee reduction.

14. The method for determining fuel pumping costs according to claim 11, said step of reading vehicle characteristics further comprising the step of:
reading said vehicle characteristics comprising at least one from among a vehicle type, a type of ownership of said vehicle, a predicted mileage per gallon of said vehicle, an actually computed mileage per gallon of said vehicle, an operational efficiency, and an average number of passengers carried per mile.

15. The method for determining fuel pumping costs to claim 14, said step of reading said vehicle characteristics further comprising the step of:
reading said type of ownership of said vehicle comprising at least one from among an indication of whether said vehicle is privately or publicly owned, and then whether said vehicle is owned by at least one of a senior citizen group, a person with a disability, a government worker, and a teacher.

16. The method for determining fuel pumping costs according to claim 11, said step of reading vehicle characteristics of a vehicle further comprising the step of:
wirelessly reading said vehicle characteristics of said vehicle from a computer system onboard said vehicle.

17. The method for determining fuel pumping costs according to claim 11, said step of adjusting a payment owed amount for fueling said vehicle based on said vehicle status further comprising the steps of:
comparing said vehicle status with vehicle standards; and
adjusting said payment owed amount according to a difference between said vehicle status and said vehicle standards.

18. The method for determining fuel pumping costs according to claim 11, said step of adjusting a payment owed amount for fueling said vehicle based on said vehicle status further comprising the step of:
adjusting said payment owed amount by subtracting taxes.

19. The method for determining fuel pumping costs according to claim 11, said step of adjusting a payment owed amount for fueling said vehicle based on said vehicle status further comprising the step of:
adjusting said payment owed amount by subtracting an efficient usage amount.

20. The method for determining fuel pumping costs according to claim 11, said step of adjusting a payment owed amount for fueling said vehicle based on said vehicle status further comprising the step of:
adjusting said payment owed amount by subtracting an employment incentive amount.

21. A program for determining fuel pumping costs, residing on a computer usable medium having computer readable program code means, said program comprising:
means for enabling reading of vehicle characteristics of a vehicle to be fueled utilizing said fuel pump; and
means for controlling an adjustment to a payment owed amount for fueling said vehicle based on a vehicle status determined from said vehicle characteristics.

22. The program for determining fuel pumping costs according to claim 21, said program further comprising:
means for accessing a database to determine said vehicle status based on said vehicle characteristics.

23. The program for determining fuel pumping costs according to claim 21, said program further comprising:
means for controlling an adjustment to said payment owed amount for fueling said vehicle based on said vehicle status comprising at least one from among a tax exemption, a tax rebate, an additional fee, and a fee reduction.

24. The program for determining fuel pumping costs according to claim 21, said program further comprising:
means for enabling reading of said vehicle characteristics comprising at least one from among a vehicle type, a type of ownership of said vehicle, a predicted mileage per gallon of said vehicle, an actually computed mileage per gallon of said vehicle, an operational efficiency, and an average number of passengers carried per mile.

25. The program for determining fuel pumping costs to claim 24, said program further comprising:
means for enabling reading of said type of ownership of said vehicle comprising at least one from among an indication of whether said vehicle is privately or publicly owned, and then whether said vehicle is owned by at least one of a senior citizen group, a person with a disability, a government worker, and a teacher.

26. The program for determining fuel pumping costs according to claim 21, said program further comprising:
means for enabling wireless reading of said vehicle characteristics of said vehicle from a computer system onboard said vehicle.

27. The program for determining fuel pumping costs according to claim 21, said program further comprising:
means for comparing said vehicle status with vehicle standards; and
means for controlling said adjustment to said payment owed amount according to a difference between said vehicle status and said vehicle standards.

28. The program for determining fuel pumping costs according to claim 21, said program further comprising:
means for controlling said adjustment to said payment owed is amount by subtracting taxes.

29. The program for determining fuel pumping costs according to claim 21, said program further comprising:
means for controlling said adjustment to said payment owed amount by subtracting an efficient usage amount.

30. The program for determining fuel pumping costs according to claim 21, said program further comprising:
means for controlling said adjustment to said payment owed amount by subtracting an employment incentive amount.

31. A method for receiving adjustments to an amount owed for fueling a vehicle, said method comprising the steps of:
monitoring vehicle usage information for a vehicle; and
in response to detecting a fuel pump to be utilized for fueling said vehicle, transmitting said vehicle usage information and vehicle identity information, such that said fuel pump is enabled to adjust an amount owed for said fueling of said vehicle according to said vehicle usage information and said vehicle identity information.

32. The method for receiving adjustments according to claim 31, said method further comprising the step of:
estimating said amount owed for a future fueling of said vehicle by transmitting said vehicle usage information and said vehicle identity information to a status server, wherein said status server returns a vehicle status for estimating adjustments of said amount owed for said future fueling.

33. The method for receiving adjustments according to claim 31, said step of monitoring vehicle usage information for a vehicle further comprising the step of:
monitoring at least one of a predicted mileage per gallon of said vehicle, an actually computed mileage per gallon of said vehicle, an operational efficiency, and an average number of passengers carried per mile.

34. The method for receiving adjustments according to claim 31, said step of transmitting said vehicle usage information and said vehicle identity information further comprising the step of:
utilizing at least one of an infrared transmitter and a radio frequency transmitter to control transmission of said vehicle usage information and said vehicle identity information.

35. The method for receiving adjustments according to claim 31, said method further comprising the step of:
detecting a status of a driver for said vehicle identity information from a personal information device detectable at said vehicle.

36. A system for receiving adjustments to an amount owed for fueling a vehicle, said system comprising:
a server system communicatively connected to a network;
said server system further comprising:
means for monitoring vehicle usage information for a vehicle; and
means for transmitting said vehicle usage information and vehicle identity information via said network to a fuel pump enabled to adjust an amount owed for said fueling of said vehicle according to said vehicle usage information and said vehicle identity information.

37. The system for receiving adjustments according to claim 36, said server system further comprising:
means for estimating said amount owed for a future fueling of said vehicle by transmitting said vehicle usage information and said vehicle identity information to a status server, wherein said status server returns a vehicle status for estimating adjustments of said amount owed for said future fueling.

38. The system for receiving adjustments according to claim 36, said means for monitoring vehicle usage information for a vehicle further comprising:
means for monitoring at least one of a predicted mileage per gallon of said vehicle, an actually computed mileage per gallon of said vehicle, an operational efficiency, and an average number of passengers carried per mile.

39. The system for receiving adjustments according to claim 36, said means for transmitting said vehicle usage information and said vehicle identity information further comprising:
means for utilizing at least one of an infrared transmitter and a radio frequency transmitter to control transmission of said vehicle usage information and said vehicle identity information.

40. The system for receiving adjustments according to claim 36, said server system further comprising:
means for detecting a status of a driver for said vehicle identity information from a personal information device detectable at said vehicle.

41. A program for receiving adjustments to an amount owed for fueling a vehicle, residing on a computer usable medium having computer readable program code means, said program comprising:
means for monitoring vehicle usage information for a vehicle; and
means for controlling transmission of said vehicle usage information and vehicle identity information to a fuel pump enabled to adjust an amount owed for said fueling of said vehicle according to said vehicle usage information and said vehicle identity information.

42. The program for receiving adjustments according to claim 41, said program further comprising:
means for estimating said amount owed for a future fueling of said vehicle by transmitting said vehicle usage information and said vehicle identity information to a status server, wherein said status server returns a vehicle status for estimating adjustments of said amount owed for said future fueling.

43. The program for receiving adjustments according to claim 41, said program further comprising:
means for monitoring at least one of a predicted mileage per gallon of said vehicle, an actually computed mileage per gallon of said vehicle, an operational efficiency, and an average number of passengers carried per mile.

44. The program for receiving adjustments according to claim 41, said program further comprising:
means for utilizing at least one of an infrared transmitter and a radio frequency transmitter to control transmission of said vehicle usage information and said vehicle identity information.

45. The program for receiving adjustments according to claim 41, said program further comprising:
means for detecting a status of a driver for said vehicle identity information from a personal information device detectable at said vehicle.

46. A method for determining a vehicle status, said method comprising the steps of:
receiving vehicle characteristics for a particular vehicle;
filtering a vehicle status database according to said vehicle characteristics of said particular vehicle; and
determining a vehicle status for said particular vehicle according to said filtering of said vehicle status database, wherein said vehicle status defines an adjustment to be made to an amount owed for fueling said particular vehicle.

47. The method for determining a vehicle status according to claim 46, said step of filtering a vehicle status database according to said vehicle characteristics further comprising the step of:
accessing at least one additional database according to a regional location of said particular vehicle for determining said vehicle status.

48. The method for determining a vehicle status according to claim 46, said method further comprising the steps of:
accessing an authority database;
determining said adjustment to said amount owed for fueling said particular vehicle based on said vehicle characteristics for said particular vehicle from said authority database; and
transmitting said amount owed to a requesting system.

49. A system for determining a vehicle status, said system comprising:
a server system communicatively connected to a network;
said server system further comprising:
means for receiving vehicle characteristics for a particular vehicle via said network;
means for filtering a vehicle status database according to said vehicle characteristics of said particular vehicle; and
means for determining a vehicle status for said particular vehicle according to said filtering of said vehicle status database, wherein said vehicle status defines an adjustment to be made to an amount owed for fueling said particular vehicle.

50. The system for determining a vehicle status according to claim 49, said means for filtering a vehicle status database according to said vehicle characteristics further comprising:
means for accessing at least one additional database via said network according to a regional location of said particular vehicle for determining said vehicle status.

51. The system for determining a vehicle status according to claim 49, said server system further comprising:
means for accessing an authority database via said network;
means for determining said adjustment to said amount owed for fueling said particular vehicle based on said vehicle characteristics for said particular vehicle from said authority database; and
means for transmitting said amount owed to a requesting system via said network.

52. A program for determining a vehicle status, residing on a computer usable medium having computer readable program code means, said program comprising:
means for enabling receipt of vehicle characteristics for a particular vehicle;
means for filtering a vehicle status database according to said vehicle characteristics of said particular vehicle; and
means for determining a vehicle status for said particular vehicle according to said filtering of said vehicle status database, wherein said vehicle status defines an adjustment to be made to an amount owed for fueling said particular vehicle.

53. The program for determining a vehicle status according to claim 52, said program further comprising:
means for accessing at least one additional database according to a regional location of said particular vehicle for determining said vehicle status.

54. The program for determining a vehicle status according to claim 52, said program further comprising:
means for accessing an authority database;
means for determining said adjustment to said amount owed for fueling said particular vehicle based on said vehicle characteristics for said particular vehicle from said authority database; and
means for transmitting said amount owed to a requesting system.
